(19) United States
(12) Patent Application Publication
(10) Pub. No.: US 2025/0094866 A1
(43) Pub. Date: Mar. 20, 2025

(54) RESPONDING TO HALLUCINATIONS IN GENERATIVE LARGE LANGUAGE MODELS

(71) Applicant: Oracle International Corporation, Redwood Shores, CA (US)

(72) Inventors: Zheng Wang, Sammamish, WA (US); Yazhe Hu, Bellevue, WA (US); Mengqing Guo, Redmond, WA (US); Tao Sheng, Bellevue, WA (US); Jun Qian, Bellevue, WA (US); Vinod Murli Mamtani, Bellevue, WA (US)

(21) Appl. No.: 18/678,914

(22) Filed: May 30, 2024

Related U.S. Application Data
(60) Provisional application No. 63/583,252, filed on Sep. 16, 2023.

(51) Int. Cl. G06N 20/00

(52) U.S. Cl. CPC G06N 20/00

(57) ABSTRACT

Techniques for correcting hallucinations produced by generative large language models (LLMs). In one technique, a computing system accesses first output generated by an LLM. The computing system identifies, within the first output, a plurality of assertions. The computing system determines that a first assertion in the plurality of assertions is false. The computing system generates a prompt that indicates that the first assertion is false. The computing system submits the prompt as input to the LLM. The computing system accesses second output that is generated by the LLM, where the second output includes a second assertion that is different than the first assertion and corresponds to the first assertion.

### BENEFIT CLAIM

This application claims benefit under 35 U.S.C. § 119 (e) of provisional application 63/583,252, filed Sep. 16, 2023, by Zheng Wang et al., the entire contents of which is hereby incorporated by reference. The applicant hereby rescinds any disclaimer of claim scope in the parent applications or the prosecution history thereof and advise the USPTO that the claims in this application may be broader than any claim in the parent application

### TECHNICAL FIELD

The present disclosure relates to modifying content generated by a large language model (LLM) type machine learning model to reduce hallucinations in the content. In particular, the present disclosure relates to iteratively identifying and modifying hallucinatory content in LLM-generated content, and resubmitting modified content to the LLM to remediate the hallucinatory content.

### BACKGROUND

Large language model (LLM)-type machine learning models are a type of deep learning model that combines a deep learning technique called attention in combination with a deep learning model type known as transformers to build predictive models. These predictive models encode and predict natural language writing. LLMs contain hundreds of billions of parameters trained on multiple terabytes of text. LLMs are trained to receive natural language as an input and generate natural language as output. Consequently, LLMs are extremely useful for generating natural language answers to questions formulated in natural language. Since LLMs are trained to predict the next word or token in a string of words and/or tokens, and not to identify truth, LLMs may generate hallucinatory content, or content that is false but makes sense semantically.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example hallucination fix system for iteratively modifying LLM-generated text based on content-accuracy criteria, in an embodiment;

FIG. 2 is a block diagram that depicts components of hallucination detector, in an embodiment;

FIG. 3 is a flow diagram that depicts an example process for fixing hallucinations in LLM-generated output, in an embodiment;

FIG. 4 is a block diagram that illustrates a computer system upon which an embodiment of the invention may be implemented;

FIG. 5 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for fixing hallucinations detected in output from a large language model (LLM). In one technique, a hallucination fixing system detects a false assertion in content produced by an LLM and sends, to the LLM, the false assertion and a prompt that requests the LLM to correct or fix the false assertion by generating a true assertion. The hallucination fixing system executes an iterative submission process until the LLM generates either (a) a threshold number of content iterations containing false assertions, or (b) a content iteration containing no detected false assertion.

Initially, the hallucination fixing system analyzes the content generated by the LLM to detect a set of assertions within the content. The system analyzes each assertion in the set against a knowledge base to determine if each assertion in the set is true or false. If each assertion is true, then the hallucination fixing system forwards the content to a device or account of a user that requested the content. If the hallucination fixing system determines that one or more assertions in the set are false, then the hallucination fixing system generates feedback for submission to the LLM in an iterative submission process. The feedback identifies the one or more false assertions. The feedback may include human-readable natural language input. The feedback may or may not be submitted with a prompt for new content. The LLM “learns,” based on the feedback (through finetuning), that the one or more assertions were false. Thus, the hallucination fixing system ensures that, after finetuning, the next iterative content generated by the LLM is less likely to include any assertions that have been identified as false assertions by the received feedback.

In an example, the hallucination fixing system builds a local feedback database as feedback is received. The LLM eventually outputs content that is consistent with the local feedback database. Specifically, the hallucination fixing system compares aggregated or generated content (e.g., query results) to a knowledge source that may include the local feedback database to determine whether the content conflicts with the knowledge source. The hallucination fixing system modifies the content such that it does not conflict with the knowledge source. Subsequent to the modification, the hallucination fixing system outputs the content that does not conflict with the knowledge source. The hallucination fixing system again analyzes the content generated by the LLM and repeats the iterative submission process until the LLM generates either (a) a threshold number of content iterations containing false assertions, or (b) a content iteration containing no detected false assertion.

### LLM Management Platform

A system according to one or more embodiments includes an LLM management platform. The LLM management platform includes a content-accuracy detection engine, a textual content modification engine, and a machine learning engine. The LLM management platform is communicatively connected to one or more user devices and a large language model (LLM)-type machine learning model.

A user accesses the LLM via the LLM management platform. For example, a user may generate a natural language prompt or query in a web page displayed in a web browser executing on the user's device. The user device transmits the user-generated query to the LLM management platform. The LLM management platform provides the query to the LLM. In response to the query, the LLM generates textual content. Typically, the textual content is natural-language textual content, or content presented in a grammatical structure of readable and coherent sentences and paragraphs.

The content-accuracy detection engine receives the textual content from the LLM prior to sending the textual content to the user device. The content-accuracy detection engine analyzes the textual content to (a) divide the textual content into assertions, and (b) identify inaccurate and/or false assertions.

In some examples, one or more elements of the machine learning engine may use a machine learning algorithm to determine the accuracy of assertions in textual content. The machine learning engine may generate, as an output value, a similarity score between two embeddings corresponding to two assertions. One assertion may be an LLM-generated assertion, and another assertion may be an assertion from a knowledge source identified as trusted or accurate. Alternatively, both assertions may be LLM-generated based on the same input prompt to the LLM. In this example, if the machine learning model identifies two assertions as being dissimilar, then the system determines one of the assertions is inaccurate and/or false.

One or more embodiments are implemented as a large language model (LLM). LLMs are a type of deep learning model that combines a deep learning technique called attention in combination with a deep learning model type known as transformers to build predictive models. These predictive models encode and predict natural language writing.

LLMs contain hundreds of billions of parameters trained on multiple terabytes of text. LLMs are trained to receive natural language as an input. LLMs typically generate natural language as an output. In addition, some LLMs may be trained to output computer code, visual output (such as images), and audio output. LLMs are made up of layers of attention mechanisms and neural networks that process input data in parallel. The layers of attention mechanisms and neural networks operating in parallel allow the LLM to learn complex patterns in text. The attention mechanisms help neural networks to learn the context of words in the sequences of words. An attention mechanism operates by breaking down a set of input data, such as a sentence or sequence of words or tokens, into keys, queries, and values. Keys represent elements of the input data that provide information about what to pay attention to. Queries represent elements of the input data that need to be compared with the keys to determine relevance. Values are elements of the input data that will be selected or weighted based on the attention scores. The attention mechanism calculates a similarity score between each query and key pair. This score reflects how relevant each key is to a given query. Various methods can be used to compute these scores, such as dot-product, scaled dot-product, or other custom functions. The similarity scores are then transformed into attention weights. For example, a system may transform the similarity scores using a softmax function. The softmax function adjusts the values of the similarity scores relative to each other such that the sum of the similarity scores is 1. Finally, the attention weights are used to take a weighted sum of the corresponding values. This weighted sum represents the model's focused or “attended” representation of the input data. In one or more embodiments, the attention mechanisms are implemented using self-attention processes, scaled dot-product attention processes, and multi-head attention processes.

In operation, the LLM receives a natural language prompt as input data and generates a sequence of words in natural language by predicting a next word, or sequence of words, based on the textual and grammatical patterns learned by the LLM during training.

In an embodiment, the LLM management platform is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### Hallucination Fix System

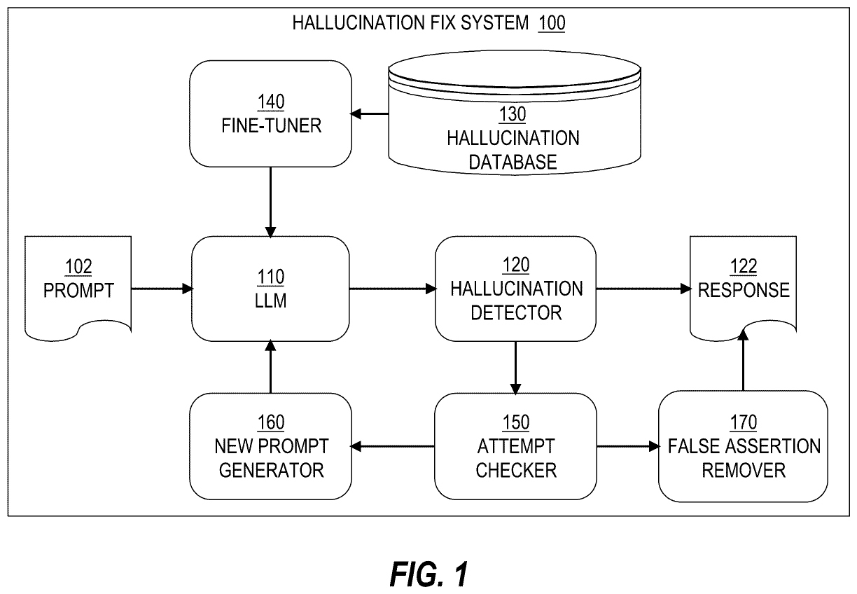

FIG. 1 is a block diagram that depicts an example hallucination fix system 100 for iteratively modifying LLM-generated text based on content-accuracy criteria, in an embodiment. One or more operations indicated in FIG. 1 may be modified, rearranged, or omitted all together. Accordingly, the particular sequence of operations indicated in FIG. 1 should not be construed as limiting the scope of one or more embodiments.

Hallucination fix system 100 comprises an LLM 110, a hallucination detector 120, a hallucination database 130, a fine-tuner 140, an attempt checker 150, a new prompt generator 160, and a false assertion remover 170, and. Each of LLM 110, hallucination detector 120, fine-tuner 140, attempt checker 150, new prompt generator 160, and false assertion remover 170 may be implemented in software, hardware, or any combination of software and hardware.

Hallucination fix system 100 receives a prompt 102, which may be composed by a user operating a computing device, such as a laptop computer, a desktop computer, a tablet computer, or a smartphone. Prompt 102 comprises natural language content, such as a question or a statement. Hallucination fix system 100 inputs prompt 102 to LLM 110, which generates output in response, which output is textual content. Prompt 102 may be modified to include a prompt identifier and a number of times that the prompt (or a related prompt) has been input to LLM 110. The number of times is initially 0 or 1. Prompt 102 may also include a request to include the prompt identifier and the number of times in any output that LLM 110 generates. This prompt identifier and time may be used by other components of hallucination fix system 100 (e.g., attempt checker 150) to determine how many times prompt 102 (or a related prompt to fix false assertions arising from prompt 102) has been processed.

However, such a prompt identifier is not necessary if, in an embodiment, LLM 110 is locked to receiving (and processing) other prompts while prompt 102 and other prompts that are triggered based on prompt 102 are processed by LLM 110 and other components of hallucination fix system 100. Thus, LLM 110 will not process another prompt from the same or different requesting entity until a response is finally generated based on prompt 102.

### Hallucination Detector

Hallucination detector 120 identifies one or more assertions in the output and determines whether each assertion is true or false. If all assertions are determined to be true (meaning it is determined that there are no hallucinations in any of the assertions identified by hallucination detector 120), then the output from LLM 110 becomes output that is transmitted to a requesting entity as a response 122. Response 122 may be transmitted over one or more computer networks, such as a local area network (LAN), a wide area network (WAN), or the Internet.

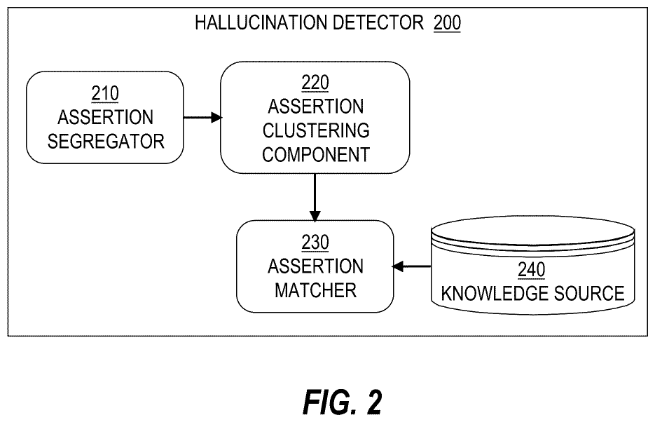

FIG. 2 is a block diagram that depicts example components of hallucination detector 200, in an embodiment. Hallucination detector 200 corresponds to hallucination detector 120. Hallucination detector 200 comprises an assertion segregator 210, an assertion clustering component 220, an assertion matcher 230, and a knowledge source 240. In other implementations, there may be more or fewer components than the ones described. For example, assertion segregator 210 and assertion clustering component 220 may be implemented as a single component that performs both functions.

Assertion segregator 210 segregates output from LLM 110 into multiple assertions. A “simple” assertion segregator 210 may treat each sentence in output as a separate assertion. However, a single sentence may include multiple assertions. For example, a sentence in LLM output may state: “As economist Victor Berg points out, wage councils ‘are not a good way to address the problem of low wages.’” Assertion segregator 210 identifies multiple assertions in this text, including: (a) Victor Berg is an economist, and (b) Victor Berg stated wage councils “are not a good way to address the problem of low wages.” Assertion segregator 210 may further recognize that content within a quotation represents a person's words, which quotation may or may not be considered an assertion.

As another example, a sentence may include a preamble and a list of items, where the preamble may be added to each item in the list to generate a different sentence. Thus, assertion segregator 210 may restructure a sentence to generate multiple assertions.

Assertion clustering component 220 generates one or more clusters of assertions, where each cluster includes one or more assertions. Thus, a single cluster may include many assertions. A purpose of assertion clustering component 220 is to cluster (or group) assertions that have similar meaning. Thereafter, only a strict subset of the assertions (e.g., one assertion) in a cluster is selected for checking whether the assertion(s) in that strict subset is/are true or false. Thus, assertion clustering component 220 helps reduce the latency of hallucination fix system 100 by reducing the number of assertions that need to be checked.

In order to cluster, assertion clustering component 220 may determine an embedding for each assertion and then compare each embedding with each other embedding. An embedding generator generates each embedding and may be part of assertion clustering component 220 or may be separate therefrom. Computing a difference between two embeddings involves computing a distance between the embeddings in n-dimensional space, presuming that each embedding comprises n values, each corresponding to a different dimension.

If the difference between two embeddings is less than a pre-defined threshold, then the two embeddings may be assigned to the same cluster. Alternatively, assertion clustering component 220 implements a clustering technique, such as K-means clustering, hierarchical clustering (agglomerative), DBScan (Density-based spatial clustering of applications with noise), GMM (Gaussian Mixture Model), BIRCH (balanced iterative reducing and clustering using hierarchies), and Affinity Propagation. A clustering technique may use actual text or may use embeddings to perform the clustering.

Once a cluster is formed, one or more representative assertions from the cluster are selected for checking against knowledge source 240. A representative assertion may be an assertion that is in the “center” of the cluster, or whose embedding is closest to the average/median embedding of the cluster. As another example, assertions that are on opposite sides of a cluster are selected as representative assertions of a cluster.

Assertion matcher 230 matches an assertion from assertion segregator 210 (or directly from assertion clustering component 220) with data from knowledge source 240. Assertion matcher 230 may compare the text and/or embedding of an assertion with a “fact” (or claim or assertion) in knowledge source 240. Knowledge source 240 may be domain specific or domain agnostic, meaning that it contains data from multiple domains. For example, knowledge source 240 may be limited to containing data pertaining to the medical field, or to sports. As another example, knowledge source 240 may contain data from many fields of endeavor.

In the context of summarization where a prompt requests that LLM 110 summarize a document or set of documents, knowledge source 240 may be limited to the document or set of documents. In the generative context (i.e., not summarization), knowledge source 240 may contain many documents, including documents on which LLM 110 was trained. In such a context, knowledge source 240 comprises a set of documents that have been identified (manually and/or automatically) as trusted, accurate, and/or factual. The set of documents may be stored locally relative to hallucination fix system 100, stored remotely in a cloud-based network, or may comprise community-based documents, such as Wikipedia.

To prevent comparing an assertion from assertion segregator 210 to each “fact” or statement in knowledge source 240, assertion matcher 230 may use an index to locate statements that are reasonably close to the assertion, at least in meaning. The index may comprise entries of embeddings in a tree like structure that allows assertion matcher 230 to skip the vast majority of statements in knowledge source 240. The “matching” that assertion matcher 230 performs may involve comparing the assertion's embedding to an embedding of a statement selected from knowledge source 240. If ten statements are found using the index and assertion matcher 230 determines that an assertion matches (or is confirmed by) one of those ten statements, then assertion matcher 230 determines that the assertion is factual and, therefore, not a hallucination.

In another embodiment, hallucination fix system 100 checks for accuracy of LLM-generated textual content by re-submitting an identical prompt to LLM 110 multiple times and checking for consistency among the responses. For example, hallucination fix system 100 applies a machine learning model to LLM-generated responses to encode the responses as embeddings. System 100 identifies a similarity among the responses by determining a distance between embeddings in n-dimensional space. If the similarity is within a certain pre-defined threshold, then the responses are considered consistent and it is presumed that the LLM-generated responses are accurate and do not contain hallucinations.

In a related embodiment, system 100 generates a sub-query for each assertion identified in output from LLM 110. For example, LLM 110 generates a string: “As economist Victor Berg points out, wage councils ‘are not a good way to address the problem of low wages.’” System 100 may identify the assertions in the text including: (a) Victor Berg is an economist, and (b) Victor Berg stated wage councils “are not a good way to address the problem of low wages.” System 100 may generate a question associated with each assertion, including: “Is Victor Berg an economist?” and “Did Victor Berg say that wage councils are not a good way to address the problem of low wages?” System 100 provides the questions to LLM 110. If the responses are different than the initial LLM-generated text, then hallucination detector 120 determines if the initial LLM-generated text was inaccurate or false.

In an embodiment, an accuracy criterion is that each assertion identified in LLM-generated output must be classified as (or determined to be) true or accurate. Alternatively, the accuracy criterion may be some value less than 100%. For example, hallucination fix system 100 may determine that LLM-generated textual content is factual if 95% or more of the assertions in the textual content are considered factual or accurate.

Based on determining LLM-generated textual content meets the one or more accuracy criteria, hallucination detector 120 transmits the textual content to a requesting device or application. For example, a user enters a natural language prompt into a web page of a user's device. The device transmits the prompt to hallucination fix system 100, which causes LLM 110 to generate textual content, which hallucination detector 120 analyzes. If the textual content meets the accuracy criteria, then hallucination detector 120 causes the textual content to be transmitted the user device to be presented on the web page as a response to the prompt.

### Hallucination Detected

In an embodiment, in response to hallucinating detector 120 identifying one or more assertions in LLM-generated output as inaccurate or false (regardless of whether the entirety of the output is considered sufficiently accurate), hallucination detector 120 causes the one or more assertions to be stored in hallucination database 130. Hallucination detector 120 also causes, for each identified assertion, one or more statements (from knowledge source 240) that prove or show that the identified assertion is incorrect to be stored (in hallucination database 130) in association with the identified assertion. Thus, hallucination database 130 stores multiple entries, one for each false/inaccurate assertion. Each entry indicates a false assertion and one or more statements that have accurate information for that assertion.

Fine-tuner 140 fine-tunes or retrains LLM 110 based on entries in hallucination database 130. The retraining causes LLM 110 to learn what content was inaccurate and what content is accurate. Thereafter, LLM 110 should produce accurate content when receiving the same or similar prompt to the one that triggered the inaccurate assertion.

### Attempt Checker

In response to hallucination detector 120 determining that one or more assertions are false or inaccurate (or the LLM-generated output fails the accuracy criteria), attempt checker 150 determines whether a threshold number of attempts have been made to improve the accuracy of assertions within the output generated by LLM 110. The threshold number of attempts may be a value assigned by an entity to limit the usage of LLM 110.

In an embodiment, the value is based on a size of the textual content. For example, a paragraph of text (e.g., 3-6 sentences) may be assigned a relatively high threshold number. Multiple paragraphs of text (e.g., 7+ sentences) may be assigned a relatively low threshold number to prevent excessive use of computing resources. The threshold may correspond to the number of attempts to generate a correct assertion based on an initial inaccurate or false assertion. Alternatively, the threshold may correspond to a number of attempts to generate a set of correct assertions from a set of multiple inaccurate or false assertions extracted from the textual content generated by LLM 110.

In an embodiment, attempt checker 150 (or another component of hallucination fix system) determines a number of false assertions identified by hallucination detector 120. If the number of false assertions exceeds a threshold, then hallucination fix system 100 may determine that attempts to “fix” the LLM-generated output is not prudent. For example, LLM 110 might not be performing well in certain domains of knowledge. Therefore, if LLM 110 generated so many false assertions, then it is unlikely to be capable of correcting those false assertions. In a related embodiment, the threshold varies based on the size of the LLM-generated output or the number of assertions detected in the LLM-generated output. Thus, the greater the size of the LLM-generated output, the greater the number of false assertions that are tolerated, at least in the initial round.

In an embodiment, for second and subsequent analyses by attempt checker 150 for a given initial prompt, a change in the number of false assertions in the second and/or subsequent checks by attempt checker 150 is a factor in determining whether to invoke new prompt generator 160 for the newly detected false assertions or to “break out” and proceed to false assertion remover 170. For example, if the current number of false assertions is the same as (or within 25% of) the number of false assertions detected in a previous invocation of hallucination detector 120 given an initial prompt, then false assertion remover 170 is called rather than new prompt generator 160. This is due to the fact that LLM 110 is not performing well in correcting previous false assertions and there is a desire to conserve computing resources by invoking LLM 110 as minimally as possible.

In a related embodiment, both the number of attempts and the change in the number of false assertions are factors in determining whether to invoke new prompt generator 160 or false assertion remover 170. These two factors may be inclusive (meaning both factors need to be triggered in order to cause false assertion remover 170 to be invoked) or exclusive (meaning triggering either factor causes false assertion remover 170 to be invoked). For example, in an exclusive scenario, a threshold number of attempts may be three and a change in the number of false assertions may be greater than or equal to 20% (e.g., five false assertions to four false assertions). If the actual number of attempts is three, but the change in the number of false assertions from the last invocation of LLM 110 was 25% of the previous number of false assertions, then new prompt generator 160 is invoked to correct the current false assertions.

### New Prompt Generator

If the threshold number of attempts has not been met, then attempt checker 150 initiates a set of operations to improve the accuracy of the LLM-generated output. Attempt checker 150 provides one or more false assertions to new prompt generator 160, which generates a new prompt that requests LLM 110 to generate a new set of text. The new prompt may include one or more false assertions and an instruction to correct the one or more false assertions. For example, an express prompt may include a statement: “Write a sentence describing the life of John Doe that does not include the false assertion that John Doe was married to Jane Doe.” As another example, an express prompt may include a statement: “Correct this false assertion” and then include the assertion that hallucination detector 120 identified as false.

In an embodiment, new prompt generator 160 includes, in the new prompt, a prompt identifier (which may be extracted from the output generated by LLM 110) and increments a value (in the output) that indicates a number of times that the initial prompt and/or subsequent prompts based on that initial prompt have been processed by LLM 110. If the initial value was 1, then new prompt generator 160 increases that value to 2. This value helps attempt checker 150 to perform its functions. This embodiment is useful if LLM 110 is able to process multiple initial prompts simultaneously. If LLM 110 is blocked from processing multiple initial prompts simultaneously, then a prompt identifier and an initial value are not necessary.

In another embodiment, the input to LLM 110 is a trigger that does not include an explicit prompt. For example, a trigger may include a statement, in association with an LLM-generated assertion “John Doe married Jane Doe in 1984”, that “John Doe did not marry Jane Doe.”

In an embodiment, new prompt generator 160 generates a text modification prompt that includes (1) the LLM-generated output and (2) one or more tags to indicate (to LLM 110) that a new set of textual content should be generated, based on the LLM-generated output, but satisfying the accuracy criteria. For example, new prompt generator 160 tags, within the initial LLM-generated output, particular assertions that have been identified as being inaccurate or false. In a related embodiment, the text modification prompt includes a natural language statement indicating which particular assertions in the LLM-generated text are inaccurate or false. In addition, or in the alternative, the text modification prompt may include an excerpt from a ground-truth source (or a link thereto) associated with a false assertion.

New prompt generator 160 submits the new prompt to LLM 110, the new prompt causing LLM 110 to generate new textual content. For example, new prompt generator 160 provides, to LLM 110: (a) an assertion that is identified as inaccurate or false and (b) an express prompt, a triggering statement, or a tag or label indicating which assertion is inaccurate or false.

In an embodiment, providing the false assertion to LLM 110 includes refraining from re-submitting, to LLM 110, assertions that were determined to be accurate or true. In other words, new prompt generator 160 resubmits the inaccurate LLM-generated assertions and corresponding prompt to LLM 110, without resubmitting other LLM-generated assertions that were not determined to be false.

LLM 110 generates new output based on the (a) false assertion and (b) prompt identifying the assertion as inaccurate. If hallucination detector 120 determines that the new output is accurate (i.e., containing no false assertions), then hallucination fix system 100 provides the new output to a requesting entity (e.g., an entity that submitted the original prompt to hallucination fix system 100). If the new output is a correction only for the false assertions, then false assertion remover 170 modifies the previously-generated textual content to replace the initial, false assertion(s), with the new, accurate assertion(s). Hallucination fix system 100 then transmits the modified textual content, including the newly-generated accurate assertions, to the requesting entity. If the new output is a regeneration based on the original prompt along with a prompt to remove a false assertion, then false assertion remover 170 is not necessary and the entirety of the new output may be forwarded to the requesting entity.

In an embodiment, if hallucination detector 120 identifies multiple false assertions, then new prompt generator 160 (or another component of hallucination fix system 100, such as attempt checker 150) determines how many false assertions will be submitted to LLM 110 in a new prompt. For example, it may be known that LLM 110 does not perform well in correcting more than two false assertions at a time. Therefore, the maximum number of false assertions to include in a new prompt is two. Thus, new prompt generator 160 may apply a pre-defined threshold when determining how many false assertions to include in a new prompt. If there are false assertions remaining after applying the pre-defined threshold (i.e., and including that number of false assertions in a first new prompt), then the remaining false assertions will be included in one or more other new prompts.

### False Assertion Remover

False assertion remover 170 performs a remediation action associated with the inaccuracies within the textual content. For example, false assertion remover 170 removes, from output generated by LLM 110, one or more assertions that have been identified as false. As another example, false assertion remover 170 identifies one or more false assertions in the output (response 122) before sending the output to a requesting entity. False assertion remover 170 may flag, annotate, or otherwise highlight each false assertion to alert a reader that the assertion is false.

False assertion remover 170 may be invoked by attempt checker 150. Such invocation may be performed in response to determining that an attempt threshold has been met. Additionally or alternatively, such invocation may be performed in response to determining that assertions that have been identified by hallucination detector 120 are not being corrected by the combination of new prompt generator 160 and LLM 110.

In an embodiment, false assertion remover 170 replaces false assertions with accurate content by stating the opposite of the false assertion. For example, if a prompt to LLM 110 requests economist Victor Berg's position on wage councils, if LLM 110 generated a response with a quotation by Victor Berg associated with wage councils, and if hallucination detector 120 determines that Victor Berg did not make any statements published in known documents regarding wage councils, then false assertion remover 170 modifies the LLM-generated response to state “economist Victor Berg is not known to have taken any position with respect to wage councils.”

In an embodiment, for assertions that hallucination detector 120 identified as false and that were fixed with one or more new prompts to LLM 110, those false assertions are replaced with factual information. For example, assertion matcher 230 identifies a statement in a set of trusted documents that contradicts an assertion that is generated by LLM 110. Hallucination fix system 100 (or false assertion remover 170) replaces the assertion in the LLM-generated text with the statement from one or more trusted documents. A response that includes (1) factual assertions and (2) statements that replaced false assertions may include text or other data (e.g., bold, underline, italics, highlights, icons, different font, different colors, or other graphics) that identifies which content in the response includes statements that replaced false assertions.

In an embodiment where hallucination fix system 100 identifies inaccuracy in LLM-generated textual content by repeatedly providing LLM 110 with the same prompt and comparing the LLM-generated responses, hallucination fix system 100 may not have a ground-truth assertion. Accordingly, false assertion remover 170 may instead generate a notification together with the text identified as potentially inaccurate or false. The notification may inform a user that a particular assertion may be inaccurate or false.

### Process Over View

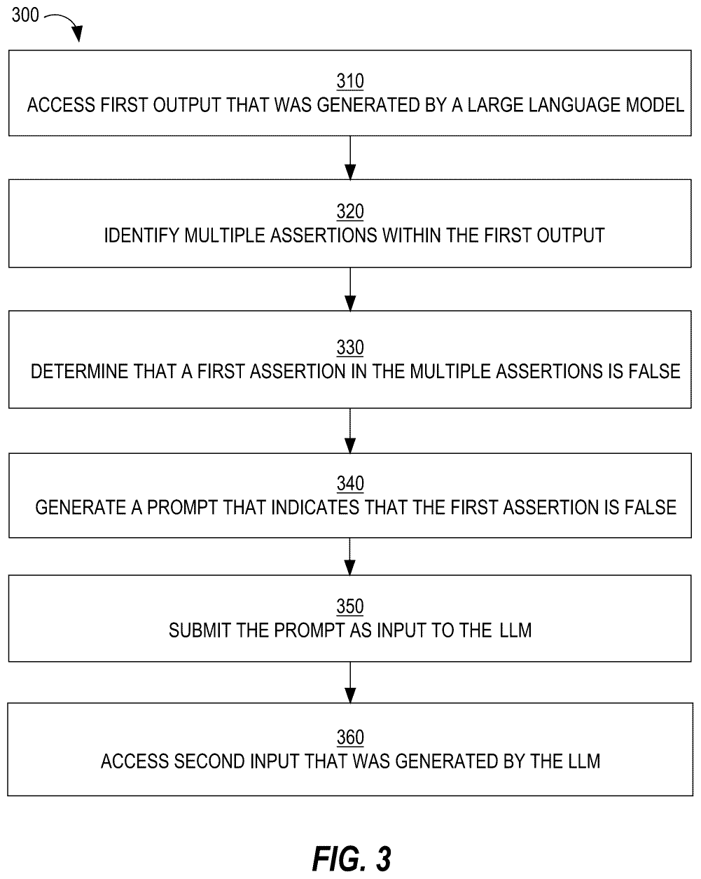

FIG. 3 is a flow diagram that depicts an example process 300 for fixing hallucinations in LLM-generated output, in an embodiment. Process 300 is implemented by different components of hallucination fix system 100.

At block 310, first output generated by a large language model (e.g., LLM 110) is accessed. Block 310 may have been preceded by hallucination fix system 100 receiving a request for data, where the request includes a prompt to LLM 110. LLM 110 generates the first output based on the prompt. Therefore, block 310 may be performed by hallucination detector 120 accessing the output of LLM 110. Hallucination detector 120 may repeatedly check a database or other storage for new output generated by LLM 110.

At block 320, multiple assertions within the first output are identified. Block 320 may be performed by assertion segregator 210 of hallucination detector 120.

At block 330, a first assertion in the multiple assertions is determined to be false. Block 330 may involve first clustering the multiple assertions and then, for each generated cluster, selecting a representative assertion from that cluster. Then, the first assertion is compared to statements in a knowledge source. If the first assertion has no basis in the knowledge source or contradicts a statement in the knowledge source, then the first assertion may be classified as false, misleading, or unsupported.

At block 340, a prompt that indicates that the first assertion is false is generated. Block 340 may be preceded by a check to determine if a number of attempts to correct false assertions has exceeded a certain threshold number. During the first iteration, this check would return false. Thus, new prompt generator 160 may be invoked and perform block 340. The prompt may include the original prompt and/or the first output.

At block 350, the prompt is submitted as input to the LLM. Block 350 may also be performed by new prompt generator 160.

At block 360, second output that is generated by the LLM is accessed. The second output includes a second assertion that is different than the first assertion and corresponds to the first assertion.

Process 300 may proceed to check whether the second assertion is false. For example, hallucination detector 120 determines whether the second assertion is false. If not and there are no more assertions that are determined to be false, then a response is generated for the initial request that triggered the LLM. The response includes assertions that were determined to be true, including assertions that were corrected using embodiments described herein. If there still remains uncorrected false assertions and the number of attempts to correct is greater than a threshold number, then a response may still be generated, but the response either excludes the assertions that have been determined to be false or includes such assertions but includes data that identifies those assertions as false.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

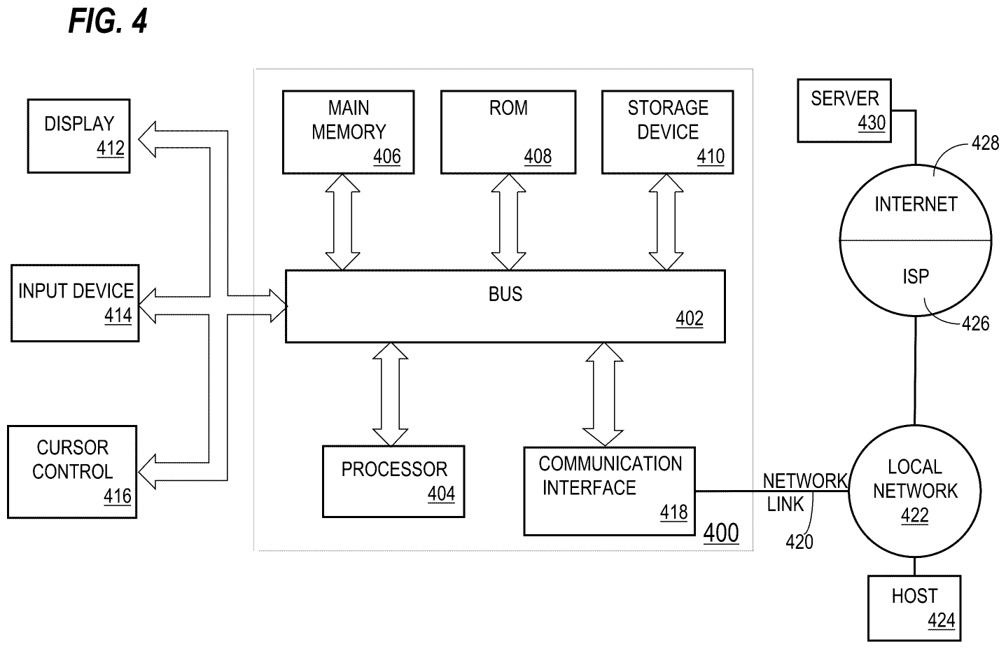

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

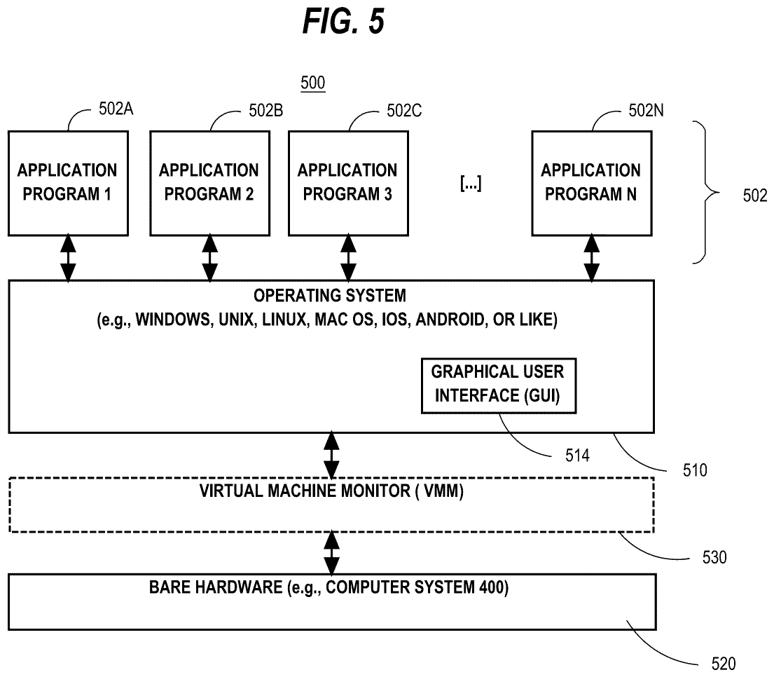

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
accessing, by a computing system, first output generated by a large language model (LLM);
identifying, by the computing system, within the first output, a plurality of assertions;
determining, by the computing system, that a first assertion in the plurality of assertions is false;
generating, by the computing system, a prompt that indicates that the first assertion is false;
submitting, by the computing system, the prompt as input to the LLM;
accessing, by the computing system, second output generated by the LLM, wherein the second output includes a second assertion that is different than the first assertion and corresponds to the first assertion;
wherein the method is performed by one or more computing devices.

2. The method of claim 1, further comprising:
determining, by the computing system, that the second output generated by the LLM is free from false assertions; and
in response to determining that the second output is free from false assertions, (a) storing the second output in persistent memory or (b) causing a portion of the first output and the second assertion to be transmitted to a requesting entity that provided, to the LLM, initial input that caused the LLM to generate the first output.

3. The method of claim 2, further comprising:
in response to determining that the second output is free from false assertions:
replacing, in the first output, the first assertion with the second assertion to generate modified first output;
causing the modified first output to be transmitted to the requesting entity.

4. The method of claim 1, further comprising:
storing, in a database, an association between the first assertion and the second assertion;
retraining the LLM based on the association.

5. The method of claim 1, further comprising:
prior to accessing the first output:
receiving, by an LLM management application, a user request from a user application, wherein the LLM management application is configured to quality check assertions generated by the LLM;
generating, by the LLM management application, a first prompt based on the user request;
submitting, by the LLM management application, the first prompt to the LLM to obtain the first assertion, wherein the generation and submission of the first input is executed by the LLM management application; and
subsequent to determining that the second assertion is true: forwarding, by the LLM management application, the second assertion to the user application.

6. The method of claim 1, further comprising:
identifying a particular assertion in the second output;
determining, by the computing system, whether the particular assertion is false;
in response to determining, by the computing system, that the particular assertion is false, determining whether to generate a subsequent prompt to correct the particular assertion.

7. The method of claim 6, wherein determining whether to generate the subsequent prompt to correct the particular assertion comprises:
determining a number of attempts the computing system has made to correct output from the LLM given an initial prompt that caused generation of the first output;
comparing the number of attempts to a threshold number of attempts;
generating a second prompt if it is determined that the number of attempts is less than or equal to the threshold number of attempts.

8. The method of claim 6, further comprising:
in response to determining, by the computing system, to not correct the particular assertion, generating a response that (a) includes one or more assertions, in the plurality of assertions, that have been determined to be true and (b) excludes the particular assertion.

9. The method of claim 6, further comprising:
in response to determining, by the computing system, to not correct the particular assertion, generating a response that includes (1) one or more assertions, in the plurality of assertions, that have been determined to be true and (2) data that indicates that the particular assertion is false.

10. The method of claim 1, further comprising:
performing, by the computer system, a clustering technique to generate, from the plurality of assertions, a plurality of clusters of assertions;
for each cluster in the plurality of clusters:
selecting a strict subset of the assertions in said each cluster;
determining whether each assertion in the strict subset of the assertions is true.

11. One or more non-transitory storage media storing instructions which, when executed by one or more computing devices, cause:
accessing, by a computing system, first output generated by a large language model (LLM);
identifying, by the computing system, within the first output, a plurality of assertions;
determining, by the computing system, that a first assertion in the plurality of assertions is false;
generating, by the computing system, a prompt that indicates that the first assertion is false;
submitting, by the computing system, the prompt as input to the LLM;
accessing, by the computing system, second output generated by the LLM, wherein the second output includes a second assertion that is different than the first assertion and corresponds to the first assertion.

12. The one or more storage media of claim 11, wherein the instructions, when executed by the one or more computing devices, further cause:
determining, by the computing system, that the second output generated by the LLM is free from false assertions; and
in response to determining that the second output is free from false assertions, (a) storing the second output in persistent memory or (b) causing a portion of the first output and the second assertion to be transmitted to a requesting entity that provided, to the LLM, initial input that caused the LLM to generate the first output.

13. The one or more storage media of claim 12, wherein the instructions, when executed by the one or more computing devices, further cause:
in response to determining that the second output is free from false assertions:
replacing, in the first output, the first assertion with the second assertion to generate modified first output;
causing the modified first output to be transmitted to the requesting entity.

14. The one or more storage media of claim 11, wherein the instructions, when executed by the one or more computing devices, further cause:
storing, in a database, an association between the first assertion and the second assertion;
retraining the LLM based on the association.

15. The one or more storage media of claim 11, wherein the instructions, when executed by the one or more computing devices, further cause:
prior to accessing the first output:
receiving, by an LLM management application, a user request from a user application, wherein the LLM management application is configured to quality check assertions generated by the LLM;
generating, by the LLM management application, a first prompt based on the user request;
submitting, by the LLM management application, the first prompt to the LLM to obtain the first assertion, wherein the generation and submission of the first input is executed by the LLM management application; and
subsequent to determining that the second assertion is true: forwarding, by the LLM management application, the second assertion to the user application.

16. The one or more storage media of claim 11, wherein the instructions, when executed by the one or more computing devices, further cause:
identifying a particular assertion in the second output;
determining, by the computing system, whether the particular assertion is false;
in response to determining, by the computing system, that the particular assertion is false, determining whether to generate a subsequent prompt to correct the particular assertion.

17. The one or more storage media of claim 16, wherein determining whether to generate the subsequent prompt to correct the particular assertion comprises:
determining a number of attempts the computing system has made to correct output from the LLM given an initial prompt that caused generation of the first output;
comparing the number of attempts to a threshold number of attempts;
generating a second prompt if it is determined that the number of attempts is less than or equal to the threshold number of attempts.

18. The one or more storage media of claim 16, wherein the instructions, when executed by the one or more computing devices, further cause:
in response to determining, by the computing system, to not correct the particular assertion, generating a response that (a) includes one or more assertions, in the plurality of assertions, that have been determined to be true and (b) excludes the particular assertion.

19. The one or more storage media of claim 16, wherein the instructions, when executed by the one or more computing devices, further cause:
in response to determining, by the computing system, to not correct the particular assertion, generating a response that includes (1) one or more assertions, in the plurality of assertions, that have been determined to be true and (2) data that indicates that the particular assertion is false.

20. The one or more storage media of claim 11, wherein the instructions, when executed by the one or more computing devices, further cause:
performing, by the computer system, a clustering technique to generate, from the plurality of assertions, a plurality of clusters of assertions;
for each cluster in the plurality of clusters:
selecting a strict subset of the assertions in said each cluster;
determining whether each assertion in the strict subset of the assertions is true.
